(19) United States
(12) Patent Application Publication
(10) Pub. No.: US 2019/0352168 A1
(43) Pub. Date: Nov. 21, 2019

(54) BEVERAGE DISPENSING SYSTEM AND METHOD FOR OPERATING A BEVERAGE DISPENSING SYSTEM

(71) Applicant: BSH HAUSGERAETE GMBH, Muenchen (DE)

(72) Inventor: EVGENI REHFUSS, MUENCHEN (DE)

(21) Appl. No.: 15/982,331

(22) Filed: May 17, 2018

(51) Int. Cl. B67D 1/08; B67D 7/22; B67D 7/32; H04L 29/08

(52) U.S. Cl. CPC B67D 1/0888; B67D 7/221; G06Q 50/12; H04L 67/306; H04L 67/16; B67D 7/3281

(57) ABSTRACT

A beverage dispensing system includes at least one web-enabled beverage dispenser and a web-based entity connectable with the at least one beverage dispenser via a data network, the web-based entity being adapted to perform at least one of the following functions: a status reporting function for providing status information regarding the at least one beverage dispenser to a third party over the data network; a statistics function for providing information regarding use statistics of the at least one beverage dispenser to a third party over the data network; a stock check function for providing current information regarding stock of consumables of the at least one beverage dispenser to a third party over the data network; a consumer profile function for storing consumer preferences and providing the stored consumer preferences to the at least one web-enabled beverage dispenser; a remote diagnostics function providing a video stream and/or an audio stream to a third party over the data network; an access function enabling dispensing a beverage by the at least one beverage dispenser for a pre-determined validity period.

### BACKGROUND OF THE INVENTION

### Field of the Invention

The invention relates to a beverage dispensing system comprising at least one web-enabled beverage dispenser and a web-based entity connectable with the at least one beverage dispenser via a data network. The invention also relates to a method for operating a beverage dispensing system. The invention is particularly useful for beverage dispenser using single-use beverage containers to produce a beverage.

Beverage containers using single-use beverage containers are generally known. For example, US 2016/0255991 A1 discloses a device for dispensing a beverage includes a plurality of replaceable reservoirs, each respectively configured to contain a respective liquid ingredient. Multiple pumps are each operatively connected to a respective reservoir and configured to transfer the respective liquid ingredient from one or more of the reservoirs. Multiple nozzles are operatively connected to the plurality of pumps and configured to receive a liquid ingredient from at least one of the plurality of pumps. A single use beverage cartridge includes a second liquid ingredient and is configured to receive the liquid ingredient dispensed from the at least one of the plurality of pumps to generate a mix of the liquid ingredient with the second ingredient.

WO 2013/160318 A1 pertains to the field of the beverage preparation machines, and more particularly to a capsule adapted for delivering a beverage in a beverage producing device comprising: a storage having a memory space for storing information related to preferences of a user of the beverage producing device; a first communication interface configured to: write in the memory space the information related to the preferences of the user, received on the first communication interface; and, allow the reading of the information stored in the memory space.

WO 2017/062656 A1 discloses a method, device, and system for in-room wine purchasing and/or dispensing. In one embodiment, an administrator/user of a property management system may be able to restrict the purchase or dispensing of wine on a given wine dispensing device via a platform management subsystem and/or a user interface of the wind dispensing device. These manual restrictions may be employed in place or in addition to restricting instructions generated based on the obtained alcohol-related policy and/or regulatory information. Further, these manual restrictions may be enforced in the form of drinking hours specified by property specific policies and/or circumstances. These manual restrictions may be specified via any granularity or increment of time (e.g., hours in a day, days in a week, etc.). Also, a parental lock may be employed. The parental lock may be a logical locking mechanism imposed to inhibit/prevent the consumption of wine by underage guests. The wine dispensing device may be programmed with a parental lock using. For example, upon determining that a parental lock has been enabled, the interacting guest user is prompted via the touchscreen for a parental lock code. In one embodiment, the parental lock code may be an authorization code in the form of a sequence of numbers of any specified length. In one embodiment of the invention, the PLC may have been selected by an adult guest occupying the room. In another embodiment of the invention, the parental lock code may have been generated by a staff member or the property management system during the check-in process at the property.

US 2011/0298583 A1 discloses methods, systems, and apparatus, including computer programs encoded on a computer storage medium, for control of beverage dispensing. In one aspect, authorization data specifying that a beverage dispensing node is authorized to be activated are received. Activation data that request activation of the node are also received, where activation of the node causes a valve that controls flow of fluid to a beverage dispenser to be opened. A determination is made that the activation data are associated with a user identifier for an enabled user, where an enabled user is a user that has been enabled to activate the node. In response to receipt of the authorization data and the activation data a valve that controls flow of fluid to the beverage dispenser is opened. Data (e.g., de-authorization or de-activation data) specifying that an activated beverage dispensing apparatus be de-activated can also be received. In response to receipt of the data, the valve can be closed.

EP 2 085 000 A1 discloses a coffee brewing apparatus that comprises a corresponding coffee brewer as well as a sensor that is configured and arranged to sense food components as used by that means for brewing coffee beverages. This coffee brewing apparatus then further comprises an external network interface that is configured and arranged to facilitate interfacing with a remote resource (or resources). The coffee brewing apparatus can further comprise an end user interface and a processor that is operably coupled to the sensor, the external network interface, and the end user interface and that is configured and arranged to independently use information regarding food components as are used by the means for brewing coffee beverages to facilitate obtaining corresponding responsive information from the remote resource and to then present that information to an end user via the end user interface.

### SUMMARY OF THE INVENTION

It is the object of the present invention to at least partially overcome the problems associated with the prior art.

The object is achieved according to the features of the independent claims. Advantageous embodiments can be found, e.g., in the dependent claims and/or in the description.

The object is achieved by a beverage dispensing system, comprising at least one web-enabled beverage dispenser and a web-based entity connectable with the at least one beverage dispenser via a data network, the system being adapted to perform at least one of the following functions:
a “status reporting” function for providing information regarding the at least one beverage dispenser to a third party over the data network;
a “statistics” function for providing information regarding use statistics of the at least one beverage dispenser to a third party over the data network;
a “stock check” function for providing current information regarding stock of consumables of the at least one beverage dispenser to a third party over the data network;
a “consumer profile” function for storing consumer preferences and providing the stored consumer preferences to the at least one web-enabled beverage dispenser;
a “remote diagnostics” function providing a video stream and/or an audio stream to a third party over the data network,
an “access” function enabling dispensing a beverage by the at least one beverage dispenser for a pre-determined validity period.

This system gives the advantage that it enables several functions that simplify using, operating and/or maintaining a beverage dispenser. These functions may be implemented as software modules of the web-based entity.

Generally, the beverage dispenser may use single-use beverage containers but is not restricted to such a use. The beverage container may be disposable. The beverage dispenser may be a self-serve beverage dispenser.

The beverage container may also be called a beverage ingredient container, a beverage capsule, a beverage cartridge, etc. Particularly, the beverage container contains only part of the ingredients needed to produce the final beverage.

The beverage container may comprise at least one communication module for communication via the data network. The communication module may be a wire bound communication module, e.g., an Ethernet module, and/or a wireless communication module, e.g., a WLAN module, an LTE module, or a Bluetooth module.

A beverage may be a hot beverage, a cold beverages, a non-alcoholic beverage, an alcoholic beverages, etc.

The web-based entity may be any entity that is adapted to enable or perform the at least one function, potentially in conjunction with the at least one beverage dispenser, operator staff and/or a third party. The web-based entity may be implemented in hardware, software, or both. For example, the web-based entity may be a network server on which software is stored that enables the server to perform the at least one function. In another variant, the web-based entity may be a network-based or cloud-based software application. The web-based entity may also be called a web-based “management entity” or web-based “coordination entity”.

It is an embodiment that the function called, without limitation, “status reporting function” comprises providing one or more information of a group comprising
error messages;
information about at least one current filling level;
temperature information about at least one current temperature;
to the third party.

This supports the third-party to keep the beverage dispenser ready to dispense beverages since it enables the third-party to remotely monitor the at least one beverage dispenser. In this case, the third-party may particularly be operator staff of an establishment operating the beverage dispenser (e.g., operator staff of a hotel, a restaurant, or a café etc.). In one embodiment the status reporting function provides the above one or more information to the mobile device or a browser adapted to receive the information. This effect, the mobile device may comprise a respective application program.

The error messages may comprise messages regarding a malfunction of one or more components of the beverage dispenser. The information about at least one current filling level may comprise information regarding the filling level of a water tank, a tank for fruit juice, a tank for alcohol, etc.

It is an embodiment that providing the information comprises sending the information from the beverage dispenser to the third party. It is also an embodiment that providing the information comprises storing the information for look up by the third-party.

To provide the temperature information, the beverage dispenser may be equipped with one or more temperature sensors.

It is an embodiment that the function called, without limitation, “statistics function” comprises providing one or more information of a group comprising
type and/or number (quantity) of dispensed beverages over a given duration;
type and/or number (quantity) of consumables used over a given duration;
length of down time over a given duration;
   to the third party.

This gives the advantage that the third party gains access to information that enables optimization of the operation of the beverage dispenser.

The third party may be the operator of the beverage dispenser. In particular, the operator may adjust the beverages offered to be dispensed based on consumer behavior.

The consumables may comprise beverage containers (which may also be called capsules or cartridges), sugar, artificial sweeteners, milk, cream, etc.

It is an embodiment that the function called, without limitation, “stock check function” comprises requesting or sending an order for a consumable if the amount of this consumable has reached a predefined threshold. This advantageously enables automatically ordering stock (e.g., consumables etc.) used by the beverage dispenser to dispense beverages. In particular, the stock check function includes monitoring the amount of stock.

The third party may be the operator of the beverage dispenser. Additionally, or alternatively, the third party may be a distributor and/or seller of the consumable(s).

Linking the information regarding the stock check function with the information regarding the statistics function and further information, e.g., calendar and/or weather data, enables further improvement of the portfolio offered by the at least one beverage dispenser. For example, knowing a link between the weather and a dispensing/beverage pattern (e.g., an increase in dispensing cold, non-alcoholic beverages in warm weather during the week) helps stocking the potentially most sought after beverages and helps anticipating demand peaks.

It is an embodiment that the function called, without limitation, “consumer profile function” comprises
creating an individual consumer account;
identifying a consumer during operation of the beverage dispenser; and
storing beverage information related to the operation.

This embodiment gives the advantage that beverages ordered by a consumer at the beverage dispenser may be individualized according to the consumer's preferences. The individual consumer account is linked to a certain consumer.

Identifying the consumer links the individual consumer account to the stored beverage information.

It is an embodiment that the individual consumer account is stored in or by the web-based entity, e.g. in a database of the web-based entity.

It is an additional or alternative embodiment that the individual consumer account is stored in or by a consumer's mobile device, e.g., a smartphone. The individual consumer account may be stored in a database of the mobile device or in a database connectable with the mobile device, e.g. in the cloud.

The operation of the beverage dispenser may include choosing a beverage and/or its adjustable parameters before the beverage is dispensed. Thus, identifying a consumer during operation of the beverage dispenser may comprise identifying the customer before such choices are made, or after such choices have been made but before the beverage is dispensed.

Identifying the consumer may comprise identifying the consumer's mobile device and/or an ID associated with the consumer's mobile device, e.g. via Bluetooth, a barcode, a QR Code, an NFC code, etc. Identifying the consumer may be performed by the beverage dispenser and/or by the web-based entity.

After identification of the consumer, the consumer may choose a beverage and may accept choices related to this beverage offered from his or her individual consumer account. The consumer may also choose to retain choices made during this dispensing process that deviate from the choices stored in the individual consumer account.

It is an embodiment that the beverage information comprises at least one information/choice of the group
type and/or amount of liquids;
mixing ratio
carbonization;
temperature of the dispensed beverage;
amount of alcohol (e.g. a percentage like vol-% etc.).

It is an embodiment that consumer preferences for selected beverages are or can be marked as consumer's favorites. This simplifies producing or dispensing individually configured beverages at any beverage dispenser of the system.

In further embodiments, the consumer profile function may be expanded using identification and/or pay options, e.g. in analogy to car sharing or machine solutions in households.

The function called, without limitation, “remote diagnostics function” enables a particularly cost-effective identification and analysis of malfunctions and respective troubleshooting. Also, particularly cost-effective remote maintenance may be achieved.

The third-party may be service personnel. Thus, the service personnel do not need to be in the vicinity of the beverage dispenser to see and/or hear it for troubleshooting or maintenance. This may save call-out fees.

It is an embodiment that providing the video stream and the audio stream to the third party comprises providing the video stream and the audio stream from a mobile device to the third party, in particular service personnel. The mobile device may be handled by operator staff of the operator of the beverage dispenser. The operator staff does not need to be qualified service personnel. For example, the operator staff may use a mobile phone to generate the video stream and/or audio stream. Particularly, the operator staff (or any other person to be tasked with handling the mobile device) may be instructed by the service personnel where to move the mobile device. These instructions may be given in real time, in particular over the same data network over which the video stream and/or audio stream is streamed. Thus, for providing the video screen and/or audio stream, a bidirectional data communication link between the mobile device and a third parties' device (e.g. a computer) may be established. To establish such a link, the mobile device of the operator staff and the device of the third party may connect to the web based entity, e.g., via respective application programs. The web-based entity may establish the connection based on access authorization.

It is an embodiment that the third-party may also instruct the operator staff handling the mobile phone to perform certain operations of the beverage dispenser. For example, to check the function of a certain component, the operator staff may be instructed to activate a certain function of the beverage dispenser and then move the mobile device to a position given by the third party to generate a respective video stream and/or audio stream. This video stream and/or audio stream is then analyzed by the third party for troubleshooting and/or maintenance.

It is an embodiment that the remote diagnostics function enables the third party to remotely operate the beverage dispenser. This may simplify the task for the operator staff handling the mobile device generating the video stream and/or audio stream. Additionally, the third-party may activate certain functions and/or components of the beverage dispenser that are not are not easily accessible to the operator staff. Thus, an even more effective troubleshooting and/or maintenance is achieved.

It is an embodiment that remote diagnostics function further enables the third party to access log files of the at least one beverage dispenser. This improves the effectiveness of the third party regarding troubleshooting and/or maintenance. The log files may comprise live data and history data regarding operation and/or status of one or more components of the beverage dispenser it is an embodiment that the mobile device is a smart glasses device. Such a device may also be called “wearable computer glasses”. This embodiment is particularly advantages since it allows the operator staff that wears such a smart glasses device to particularly precisely and easily observe the beverage dispenser. It is another advantage that instructions from the third party may be particularly easy to hear if the smart glasses device also comprises a speaker. The smart glasses device may also have a microphone to generate the audio stream.

It is an embodiment that wherein the web-based entity is further adapted to perform a firmware update. Using this firmware update function enables remote maintenance and updates of software components of the beverage dispenser. In one variant the firmware update may be differentiated by the operators operating the beverage dispensers. For example, different beverages may be supported for beverage dispensers belonging to different operators. Also, different content may be displayed on displays of the beverage dispenser belonging to different operators.

The above described functions achieve the object on their own.

The object is also achieved by a method for operating a beverage dispensing system, comprising at least one web-enabled beverage dispenser and a web-based entity connectable with the at least one beverage dispenser via a data network, the method comprising one or more of the following steps:
a) dispensing a beverage by the at least one beverage dispenser for a pre-determined validity period,
b) providing status information regarding the at least one beverage dispenser to a third party over the data network;
c) providing information regarding use statistics of the at least one beverage dispenser to a third party over the data network;
d) providing current information regarding stock of consumables of the at least one beverage dispenser to a third party over the data network;
e) storing consumer preferences and providing the stored consumer preferences to the at least one web-enabled beverage dispenser;
f) providing a video stream and/or an audio stream to a third party over the data network.

The method may be embodied in analogy to the above described system, and vice versa.

For example, dispensing a beverage according to step a) may comprise the steps of:
sending a request to the web-based entity for issuing first information enabling dispensing beverage from the beverage dispenser for a pre-determined validity period;
by the web-based entity, receiving the request for issuing and issuing the first information;
by the beverage dispenser, receiving a request for dispensing a beverage and receiving second information regarding the dispensing request; and
checking whether the second information matches the first information and whether the current time is within pre-determined validity period, and if so, enabling dispensing the beverage.

This method gives the advantage that the possibility of a consumer/user of the beverage dispenser to dispense the beverage is time-limited. Thus, the consumer is forced to dispense the beverage within the pre-determined validity period which prevents holding back the container for use a later time. If the beverage dispenser uses beverage containers (also called capsules or cartridges etc.), this method also makes it considerably harder to collect multiple containers to be used in a short time or to resell or hand out beverage containers to unauthorized, e.g. underage, persons.

The pre-determined validity period may be the period starting from requesting or from issuing the information. The validity period may be defined by a starting time (e.g. “8:12 p.m.”) and a duration (e.g., “1 hour”) and/or by an end time (e.g., “9:12 p.m.”). The validity period may also comprise a date (e.g., “May-12-2018”). In analogy, the current time may comprise the time of the day and potentially the date. The pre-determined validity period may, e.g., be a fixed period, may be dependent on the type of beverage to be dispensed, and/or may be set by the operator staff.

In an embodiment, sending a request is performed or initiated by a requesting entity. The requesting entity may be a terminal operated by operator staff, e.g. an electronic register. The requesting entity may be specifically authorized to request the first information.

In another embodiment, the requesting entity may be the consumer. For example, the consumer may buy a beverage container and try to activate the dispensing of the respective beverage by sending a request to the web-based entity. This activation may be performed using a consumer's mobile terminal, e.g. using a respective application program or “app”. However, to prevent intoxication, the pre-determined validity period may be set by the web-based entity such that dispensing the respective beverage is only possible for pre-defined validity periods (e.g. not between 1 a.m. and 9 a.m.) and/or that only a certain number of beverages associated with a certain consumer may be consumed within the validity period. These checks may, in general, also by performed if the request for issuing first information is performed by the operator staff.

The beverage dispenser may receive a request from a consumer for dispensing a beverage and may receive second information from the consumer regarding the dispensing request. In one embodiment, receiving the second information corresponds to receiving the request for dispensing.

The second information may generally be any information that the consumer provides to the beverage dispenser to enable dispensing the beverage.

The checking may, e.g., be performed by the beverage dispenser, the web-based entity, or both.

It is an embodiment that issuing the first information comprises generating the first information and providing the first information to the requesting entity. For example, operator staff may operate a terminal to request the first information, the terminal sends the request to the web-based entity, the web-based entity receives the request and issues the first information by generating the first information and sending it back to the requesting entity.

It is an embodiment that the requesting entity prints the first information after having it received from the web-based entity. The first information may be printed, e.g., in form of a barcode or QR code, and handed to the consumer by the operator staff. It is also an embodiment that the requesting entity stores the first information on a transponder card, e.g. an NFC or RFID card. Alternatively, the requesting entity may provide the first information to a consumer's mobile terminal, e.g. via wireless data transfer, e.g. in form of a QR code, an NFC code, etc.

It is an embodiment that the first information is in form of a symbol code comprising letters, numbers and/or special characters like the “pound sign” etc. In particular, the symbols may be available for input into the beverage dispenser via a keypad of the beverage dispenser. This embodiment is particularly useful if the first information is handed to the consumer in printed form.

It is an embodiment that the first information is in form of an optical machine-readable code, e.g., a barcode, a QR code, etc. This gives the advantage that the first information may be received by the beverage dispenser in a particularly simple and error-free manner. To optically read the optical machine-readable code, the beverage dispenser may be equipped with a suitable reader or scanner, e.g. a barcode reader or barcode scanner. The optical machine-readable code may be printed on a piece of paper or be displayed on a mobile terminal.

It is an embodiment that the first information is in form of a wireless code, e.g., an NFC code, a RFID code, etc.). This wireless code may in particular be sent to a consumer's mobile terminal. The mobile terminal may be a laptop computer or may be a mobile device like a tablet PC, a smartphone, a phablet, a smart watch, etc.

It is an embodiment that issuing the first information comprises generating the first information and providing the first information to a pre-defined mobile terminal. This mobile terminal may be a consumer's mobile terminal. In general, issuing the first information may comprise issuing the information to an entity different from the requesting entity. For example, operator staff may operate the terminal to request the first information and also to provide address information about an address related to a consumer's mobile terminal (e.g. an email address, a mobile phone number), the terminal then sends the request and the address information to the web-based entity, where it is received. The web-based entity then issues the first information by generating the first information and sending it to the entity specified by the address information, e.g., the consumer's mobile terminal. Sending the first information may include sending an email, an SMS, an MMS, any other type of message (e.g. a WhatsApp message etc.). At the consumer's mobile terminal, the received first information is stored (e.g., in form of a barcode, a QR code, an NFC code, etc.) for later interaction with the beverage dispenser.

It is an embodiment that issuing the first information comprises generating the first information and storing the first information by the web-based entity. This is particularly advantageous if the checking step is performed by or together with the web-based entity.

It is an embodiment that the web-based entity stores the issued information only for the pre-determined validity period. This provides a particularly simple and user-friendly checking step. Particularly, there is advantageously no need to check the current time with respect to the pre-determined validity period after finding a match. Rather, finding a match already includes or implies that the request to dispense a beverage has been made within the pre-determined validity period.

It is an embodiment that the beverage dispenser is adapted to dispense a beverage based on a beverage container to be inserted into the beverage dispenser by a consumer prior to dispensing. The above described method is particularly advantageous to prevent misuse of such containers. In one aspect, operator staff may hand out a beverage container to a consumer together with the first information, e.g. a paper slip with the first information printed on it.

In an embodiment of the invention:
the request for issuing the first information comprises an ID of the beverage container;
issuing the first information comprises storing the ID for the pre-determined validity period;
receiving the second information comprises acquiring the ID of a beverage container; and
checking comprises matching the ID acquired by the beverage dispenser with ID stored in the web-based entity, and if there is a match, dispensing the beverage.

This advantageously allows linking the first information and the ID, thus enabling an even more effective control regarding dispensing the beverage container. It is also particularly easy to implement and to use. For example, for the request to comprise the ID of the beverage container, operator staff may scan the ID of the beverage container to be handed over to a consumer. This ID is then provided to the web-based entity. In a particularly convenient embodiment, the web-based entity issues the first information by simply storing it only for the pre-determined validity period. If the consumer then approaches a beverage dispenser to dispense the beverage associated with a beverage container, the beverage dispenser may scan the ID of the beverage container inserted or to be inserted by the consumer. Then, the ID scanned by the beverage dispenser is compared with IDs stored by the web-based entity. If there is a match, dispensing a beverage using the scanned beverage container is enabled.

The ID may be attached to the beverage container, e.g., printed or etched on it, glued to it etc. The ID may be in encoded form, e.g., a barcode or a QR code. In an embodiment, the ID is encoded as an RFID code.

It is an embodiment that the ID designates the type of beverage that may be dispensed using the beverage container (e.g., “Pina Colada”, “Lime Cooler” etc.).

It is an embodiment that the ID is a unique or quasi-unique ID. This allows for a particularly effective prevention of misuse of beverage containers. Particularly in this case, it is an embodiment that the ID is part of or is the first information. This gives the advantage that the first information does not need to be calculated and distributed.

However, it is generally possible that the first information is based on the ID (derived or calculated from the ID) but is not identical to the ID. For example, the first information may be a combination of the ID and the predetermined validity period. Also, the first information may comprise further information like a transaction number, an ID of the requesting entity, an ID of the operator staff initiating the request, etc.

It is an embodiment that the checking on matching IDs is only performed if the ID is associated with pre-defined beverages or types of beverages, e.g. with alcoholic beverages. This simplifies dispensing beverages that do not need to fulfill certain requirements, e.g., lemonades, ice tea, flavored water, etc. To implement this embodiment, the beverage dispenser may be adapted to differentiate between container IDs that require checking and container IDs that do not. If a beverage container comprises a container ID (second information) that does not need to be checked against an issued/stored container ID (first information), the beverage dispenser may enable dispensing without checking. In this case, there is also no need to request dispensing a beverage and issuing the first information.

It is an embodiment that the request to dispense a beverage comprises the pre-determined validity period. This gives the advantage that the pre-determined validity period may be set individually, e.g., by the operator staff and/or depending on the type of beverage. For example, shorter validity periods may be set for beverages having a high alcohol content as compared to low alcohol drinks like beer. Also, operator staff may set shorter validity periods for certain consumers, e.g., bachelor parties.

The object is also achieved by a computer program product performing, if executed, the above described method and/or enabling the system, in particular the web-based entity, to perform its functions, as described above.

The above described features and advantages of the invention as well as their kind of implementation will now be schematically described in more detail by at least one embodiment in the context of one or more figures.

### BRIEF DESCRIPTION OF THE SEVERAL VIEWS OF THE DRAWING

FIG. 1 shows a beverage dispensing system in an embodiment adapted to perform the access function;

FIG. 2 shows process steps of a method for operating the beverage dispenser using the access function;

FIG. 3 shows process steps of a method for dispensing a beverage from the beverage dispenser using the access function;

FIG. 4 shows a beverage dispensing system in an embodiment adapted to perform the remote diagnostics function; and

FIG. 5 shows process steps of a method for performing the remote diagnostics function.

### DESCRIPTION OF THE INVENTION

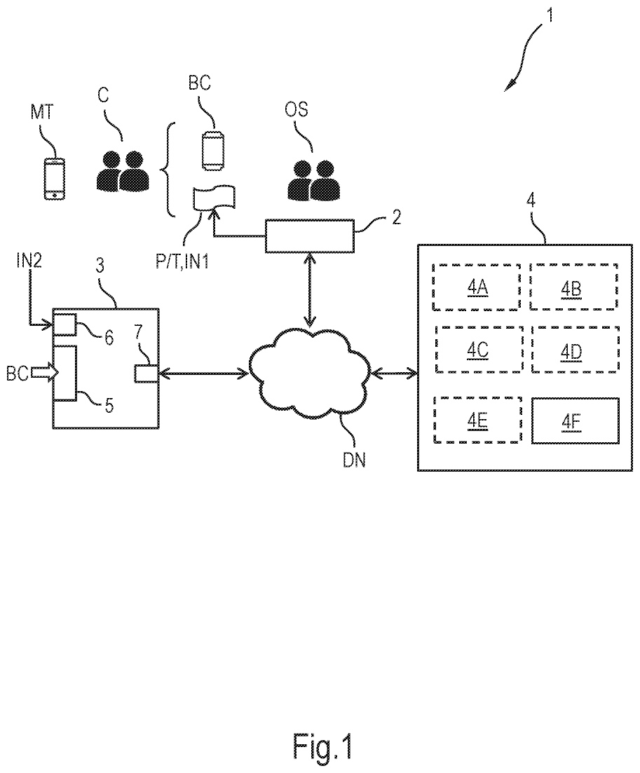

FIG. 1 shows a beverage dispensing system 1 according to a first embodiment comprising a web-enabled entity requesting entity 2, a web-enabled beverage dispenser 3 and a web-based “management” entity 4. The requesting entity 2 is connectable to the management entity 4 via a data network DN and the beverage dispenser 3 is connectable to the management entity 4 via the data network DN.

The requesting entity 2 may be a terminal operated by operator staff OS, e.g. an electronic register, an ordering device, etc. The requesting entity 2 may be specifically authorized to communicate with the management entity 4.

The beverage dispenser 3 comprises a dispensing unit 5 for dispensing a beverage. To this effect, the dispensing unit 5 is adapted to receive a beverage container BC from a user/consumer C. The beverage dispenser 3 further comprises at least one information receiving unit 6, e.g. a keypad, an optical code scanner and/or a wireless code reader for acquiring “second” information IN2. The beverage dispenser 3 is adapted to acquire, via the at least one information receiving unit 6, the second information IN2, to check whether this second information IN2 is information enabling dispensing a beverage from the beverage dispenser 3 for a pre-determined validity period, and to check whether the current time is within the pre-determined validity period, and if so, to enable dispensing the beverage. The beverage dispenser 3 further comprises at least one communication module 7 for communication via the data network DN. The communication module 7 may be a wire bound communication module 7, e.g., an Ethernet module, and/or a wireless communication module 7, e.g., a WLAN module, an LTE module, or a Bluetooth module.

The management entity 4 may be a server or a cloud-based web application. The management entity 4 may comprise one or more modules, in particular, software modules representing respective functions. In particular, the management entity 4 at least comprises a module 4F for performing an access function enabling dispensing a beverage by the beverage dispenser 3 for a pre-determined validity period, as will be described in greater detail below.

The management entity 4 may further comprise:
a module 4A performing, if executed, a status reporting function for providing status information regarding the at least one beverage dispenser 3 to a third party over the data network DN;
a module 4B performing, if executed, a statistics function for providing information regarding use statistics of the at least one beverage dispenser 3 to a third party over the data network DN;
a module 4C performing, if executed, a stock check function for providing current information regarding stock of consumables of the at least one beverage dispenser 3 to a third party over the data network DN;
a module 4D performing, if executed, a consumer profile function for storing consumer preferences and providing the stored consumer preferences to the at least one web-enabled beverage dispenser 3; and/or
a module 4E performing, if executed, a remote diagnostics function providing a video stream and/or an audio stream to a third party over the data network DN.

Particularly, the beverage dispenser 3 may be adapted to check whether the current time is within the pre-determined validity period by comparing the second information IN2 acquired via the least one information receiving unit 6 with the first information IN1 stored by the management entity 4.

The management entity 4 may issue the first information IN1, e.g., by storing it, by generating and storing it, by generating and sending it to the requesting entity 2, and/or by generating and sending it to a mobile terminal MT of the consumer C, e.g. via SMS or other messaging service. If the first information IN1 is sent to the requesting entity 2, the requesting entity 2 may transfer the first information IN1 to the mobile terminal MT of the consumer C, may print it on a slip of paper P, or hand out a transponder card T (e.g. an RFID card) comprising the first information IN1.

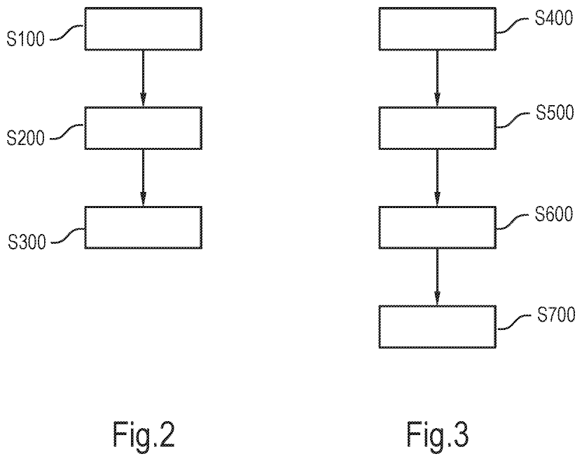

FIG. 2 shows process steps of one possible method for operating the beverage dispenser 3, comprising:
a step S100 of receiving, by the beverage dispenser 3, a request to dispense a beverage;
a step S200 of receiving, by the beverage dispenser 3, (second) information IN2 potentially enabling dispensing the beverage from the beverage dispenser 3 for a pre-determined validity period; and
a step S300 of checking whether the current time is within pre-determined validity period, and if so, dispensing the beverage. Step S300 may be preceded by or comprise a step of checking whether the received information IN2 is of a form and/or content that it potentially enables dispensing the beverage from the beverage dispenser 3 for the pre-determined validity period.

FIG. 3 shows process steps of one possible method for dispensing a beverage from the beverage dispenser 3, comprising:
a step S400 of sending, by the requesting entity 2: a request for issuing the first information IN1 to the management entity 4;
a step S500 of receiving, by a management entity 4: receiving the request for issuing the first information IN1 and then issuing the first information IN1;
a step S600 of receiving, by the beverage dispenser 3, a request for dispensing a beverage and receiving second information IN2 related to the dispensing request; and
a step S700 of checking whether the second information IN2 matches the first information IN1 and checking whether the current time is within pre-determined validity period associated with the first information IN1, and if so, dispensing the beverage or enabling dispensing the beverage.

Step S600 may be identical to step S200. Step S300 may comprise step S700, or vice versa.

Under one aspect, issuing the first information IN1 according to step S500 comprises generating the first information IN1 and providing the first information to the requesting entity 2. In one variant, the requesting entity prints the first information IN1 onto, e.g., the slip of paper P. In particular, the first information IN1 may be printed in encoded form, e.g. in form of a symbol code or an optical machine-readable code like a barcode or a QR code.

In another variant, the requesting entity 2 stores the first information IN1 on a portable storage medium, e.g., a transponder card T, especially a room card. The portable storage medium may be wirelessly readable by the information receiving unit 6, e.g. via RFID. The portable storage medium may thus comprise an NFC or RFID transponder.

In yet another variant, the requesting entity 2 stores the first information IN1 on/transfers the first information IN1 to the consumer's mobile terminal MT. consumer's mobile terminal MT may provide the first information IN1 optically (e.g. by displaying the first information IN1 on its display) or by radio transmission (e.g. by transferring the first information IN1 via NFC).

In even another variant, the first information IN1 is provided directly from the management entity 4 to the user's mobile terminal MT via the data network DN.

With the first information IN1 at hand, the consumer C may now walk to a beverage dispenser 3 (i.e., a self-serve beverage dispenser), insert the beverage container BC and input the first information IN1 into the information receiving unit 6. The first information IN1 thus corresponds to the second information IN2 received by the beverage dispenser 3.

In one variant, the first information IN1 comprises the pre-determined validity period. Then, the beverage dispenser 3 may be adapted to perform step S300 itself, i.e., without interaction with management entity 4.

In another variant, issuing the first information IN1 comprises generating the first information IN1 and storing the first information IN1 by the management entity 4. Upon receiving the second information IN2, it is checked in step S700 whether the second information IN2 matches the first information IN1. If so, it is checked whether the current time is within pre-determined validity period associated with the first information IN1, and if so, dispensing the beverage or enabling dispensing the beverage. If the second information IN2 does not match stored first information IN1, dispensing the beverage is denied. The checking in step S700 may be performed as a push operation (in which, e.g., the second information IN2 is transmitted to the management entity 4 which checks for matching first information IN1 and which checks whether the current time is within pre-determined validity period associated with the first information IN1 and which then sends back the results to the beverage dispenser 3) or as a pull operation (in which, e.g., the beverage dispenser 3 looks up a list of first information IN1 stored by the management entity 4 and checks whether the current time is within pre-determined validity period associated with the first information IN1). Thus, the pre-determined validity period may be stored together with the corresponding first information IN1.

In yet another variant, issuing the first information IN1 comprises generating the first information IN1 and storing the first information IN1 by the management entity 4 only for the pre-determined validity period. In this variant, checking whether the second information IN2 matches the first information IN1 and checking whether the current time is within pre-determined validity period associated with the first information IN1 is the same operation: if the checking step S700 finds a match of the second information IN2 and a first information IN1 stored by the management entity 4, the current time is de facto within pre-determined validity period. Likewise, if the checking step S700 finds no match between the second information IN2 and first information IN1 stored by the management entity 4, the current time is outside the pre-determined validity period.

In even another variant, the first information IN1 is or corresponds to an ID associated with the beverage container. In this case, step S400 may simply comprise sending the ID to the management entity 4 to be stored for the pre-determined validity period. In step S500, issuing the first information IN1 may only comprise storing the ID for the pre-determined validity period. The requesting entity 2 does not need to explicitly hand out any first information IN1 to a customer C but only the beverage container BC comprising the ID. In step S600, the receiving the second information IN2 may comprises reading a beverage container's ID. The checking step S700 may then only comprise checking the ID received by the beverage dispenser 3 against ID(s) stored by the management entity 4, e.g., in analogy to the step described above.

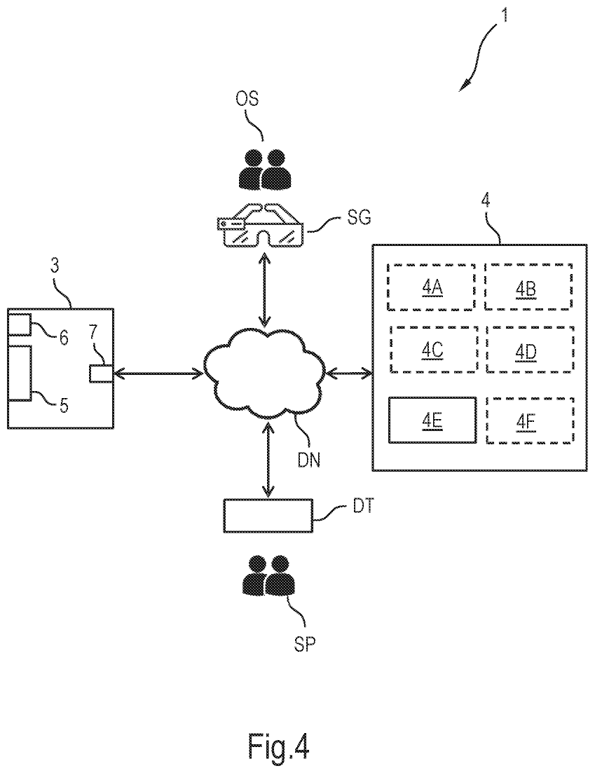

FIG. 4 shows a beverage dispensing system in an embodiment adapted to perform the remote diagnostics function. To this end, the management entity 4 of the beverage dispensing system 1 as described above also comprises the module 4E performing, if executed, the remote diagnostics function providing a video stream and/or an audio stream to a third party (here: a terminal DT operated by service personnel SP) over the data network DN. The terminal DT may be a laptop computer, a desktop computer etc.

Providing the video stream and the audio stream to the service personnel SP comprises providing the video stream and the audio stream from a mobile device in form of a smart glasses device SG to the terminal DT. The smart glass device SG may be used by the operator staff OS.

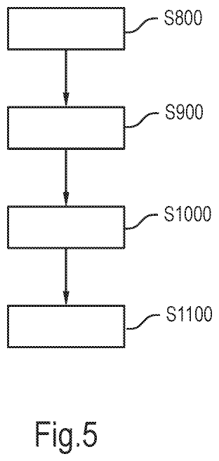

FIG. 5 shows possible process steps of a method for performing the remote diagnostics function.

In a step S800, the service personnel SP logs into the management entity 4 via terminal DT, selecting module 4E.

In a step S900, the service personnel SP selects a certain beverage dispenser 3 to be remotely diagnosed. This step may also enable accessing log files of the beverage dispenser 3 via the terminal DT, in particular, if these log files are stored by the management entity 4.

In a step S1000, the management entity 4 establishes a data connection or data link between the selected beverage dispenser 3 and the terminal DT, potentially but not necessarily via the management entity 4. This step may enable remotely operating the beverage dispenser 3 from the terminal DT. This step may also enable accessing log files of the beverage dispenser 3 via the terminal DT, in particular, if these log files are stored by the beverage dispenser.

In a step S1100, the operator staff OS logs into the management entity 4 selecting module 4E, selecting the same beverage dispenser 3 as selected in step S900 and registering/coupling the smart glasses device SG. Thus, a data connection or data link is established between the terminal DT and the smart glasses device SG, potentially but not necessarily via the management entity 4. The data connection enables sending a video stream from the smart glasses device SG to the terminal DT. If the smart glasses device SG has a microphone, an audio stream is also sent from the smart glasses device SG to the terminal DT.

To perform remote diagnostics, service personnel SP may instruct the operator staff OS that wears the smart glasses device SG to position himself or herself at the given location next to the beverage dispenser three and watch the certain area of the beverage dispenser. The instruction may be given over the data connection used for video and potentially audio streaming. Thus, the data connection may be a bidirectional data connection. Alternatively, the instruction may be given over the different data connection.

The service personnel SP may now remotely operate the beverage dispenser 3 or instruct the operator staff OS to operate the beverage dispenser 3 in a certain way and watch the result via the video stream. If there is an audio stream available, the service personnel SP may also listen to sounds made by the beverage dispenser 3 while being operated. In peril, the service personnel SP may study log files generated based on this operation and/or based on past operations (history data).

If a certain problem had been identified, the service personnel SP may instruct the operator staff OS to troubleshoot this problem, e.g., while monitoring the troubleshooting via the smart glasses device SG. This monitoring via at least the video stream may also be used to maintain the beverage dispenser 3, e.g., during routine maintenance intervals.

The remote diagnostics module 4E thus enables troubleshooting and maintaining the beverage dispenser 3 using operator staff OS monitored and instructed remotely via the data network DN by service personnel SP. If the malfunction is not to severe, it may be avoided to request presence of service personnel SP at the beverage dispenser, thus reducing or avoiding call-out fees.

It will be readily understood that the invention is not restricted to the described embodiments.

### LIST OF REFERENCE SIGNS

1 beverage dispensing system
2 requesting entity
3 beverage dispenser
4 issuing entity
4A status report module
4B statistics module
4C stock check module
4D consumer profile module
4E remote diagnostics module
4F access module
5 dispensing unit
6 information receiving unit
7 communication module
8 issuing software module
BC beverage container
C consumer
DN data network
DT terminal
IN1 first information
IN2 second information
MT Mobile terminal
OS operator staff
P paper
S100-S1100 method steps
SG smart glasses device
SP service personnel
T transponder card

1. A beverage dispensing system, comprising at least one web-enabled beverage dispenser and a web-based entity connectable with the at least one beverage dispenser via a data network, the system being adapted to perform at least one of the following functions:
a status reporting function for providing status information regarding the at least one beverage dispenser to a third party over the data network;
a statistics function for providing information regarding use statistics of the at least one beverage dispenser to a third party over the data network;
a stock check function for providing current information regarding stock of consumables of the at least one beverage dispenser to a third party over the data network;
a consumer profile function for storing consumer preferences and providing the stored consumer preferences to the at least one web-enabled beverage dispenser;
a remote diagnostics function providing a video stream and/or an audio stream to a third party over the data network;
an access function enabling dispensing a beverage by the at least one beverage dispenser for a pre-determined validity period.

2. The beverage dispensing system according to claim 1 wherein the status reporting function comprises providing one or more information of a group comprising error messages;
information about at least one current filling level;
temperature information about at least one current temperature;
to the third party.

3. The beverage dispensing system according to claim 1 wherein the statistics function comprises providing one or more information of a group comprising type and/or number of dispensed beverages over a given duration;
type and/or number of consumables used over a given duration;
length of down time over a given duration;
to the third party.

4. The beverage dispensing system according to claim 1 wherein the stock check function comprises requesting or sending an order for a consumable if the amount of this consumable has reached a predefined threshold.

5. The beverage dispensing system according to claim 1 wherein the consumer profile function comprises creating an individual consumer account;
identifying a consumer during operation of the beverage dispenser; and
storing beverage information related to the operation.

6. The beverage dispensing system according to claim 5 wherein the beverage information comprises at least one information of the group type and/or amount of liquids;
mixing ratio carbonization;
temperature of the dispensed beverage; and
amount of alcohol.

7. The beverage dispensing system according to claim 1 wherein providing the video stream and the audio stream to the third party comprises providing the video stream and the audio stream from a mobile device to the third party.

8. The beverage dispensing system according to claim 7 wherein the mobile device is a smart glasses device.

9. The beverage dispensing system according to claim 7 wherein the remote diagnostics function enables the third party to remotely operate the beverage dispenser.

10. The beverage dispensing system according to claim 7 wherein the remote diagnostics function enables the third party to access log files of the beverage dispenser.

11. The beverage dispensing system according to claim 1 wherein the web-based entity is further adapted to perform a firmware update.

12. A method for operating a beverage dispensing system, comprising at least one web-enabled beverage dispenser and a web-based entity connectable with the at least one beverage dispenser via a data network, the method comprising one or more of the following steps:
a) providing status information regarding the at least one beverage dispenser to a third party over the data network;
b) providing information regarding use statistics of the at least one beverage dispenser to a third party over the data network;
c) providing current information regarding stock of consumables of the at least one beverage dispenser to a third party over the data network;
d) storing consumer preferences and providing the stored consumer preferences to the at least one web-enabled beverage dispenser;
e) providing a video stream and/or an audio stream to a third party over the data network
f) dispensing a beverage by the at least one beverage dispenser for a pre-determined validity period.
